(19) United States
(12) Patent Application Publication
(10) Pub. No.: US 2005/0039775 A1
(43) Pub. Date: Feb. 24, 2005

(54) Process and system for cleaning surfaces of semiconductor wafers

(76) Inventor: Walter H. Whitlock, Chapel Hill, NC (US)

Correspondence Address: Paul D. Greeley, Esq.;Ohlandt, Greeley, Ruggiero & Perle, L.L.P., 10th Floor, One Landmark Square, Stamford, CT, 06901-2682, US

(21) Appl. No.: 10/643,597

(22) Filed: Aug. 19, 2003

(51) Int. Cl. B08B 3/02

(52) U.S. Cl. 134/2; 134/19; 134/25.4; 134/26; 134/31

(57) ABSTRACT

A process for cleaning the surface of a semiconductor wafer. The process has the following steps: a) conveying a component selected from the group consisting of a dense gas component, a liquid component and a mixture thereof to a bellows accumulator having a bellows therein; b) applying an elevated pressure to said bellows sufficient to discharge the component from the bellows onto said surface of the wafer; and c) contacting the component with the surface of the wafer. There is also a system for cleaning the surface of a semiconductor wafer and for mixing a dense gas component and a liquid component.

### BACKGROUND OF THE INVENTION

1. Field of the Invention

The invention relates to a process and system for cleaning the surface of a semiconductor wafer. The invention further relates to a process and system for providing dense gas component and/or a liquid component at high pressure and flow rate for cleaning a semiconductor wafer. The invention further relates to a process and system for cleaning a semiconductor wafer wherein the number and/or size of high-pressure pumps is minimized

2. Background of the Invention

Electronic chip and wafer manufacturing processes commonly employ cleaning methods utilizing mixtures of organic solvents and dense gases. A common cleaning mixture is isopropyl alcohol (IPA) and carbon dioxide. Such mixtures are typically formed and utilized at high pressures, i.e., about 1000 psia (pounds per square inch absolute) or more.

Cleaning mixtures are typically formed by mixing of component solvent and gas streams plus any additives, such as surfactants. Because of the high system pressures required for liquefaction of gases, components typically are conveyed and processed with high-pressure pumps. Because of the corrosion characteristics of some components, pumps may need to be constructed of relatively expensive, corrosion-resistant materials such as inconel, Hastelloy (trademark of ESPI) and Teflon (trademark of E. I. du Pont de Nemours & Co.). Further, while pumps are suitable for delivering streams at relatively constant flow rates, they are less suitable for delivering momentary or surge flow rates. Still further, in high-pressure cleaning systems, additives may require their own high-pressure pumps.

U.S. Pat. No. 6,306,564 B1 relates to the cleaning of the surface of a semiconductor wafer with a stripping chemical of supercritical carbon dioxide and an organic solvent.

U.S. Pat. No. 6,536,059 B1 relates to a system for the pumpless transfer of liquid carbon dioxide. The system has a working vessel for storage of liquid carbon dioxide, a vapor vessel having pressurized air and carbon dioxide and a wash vessel for cleaning articles. A portion of the pressurized gas is transferred from the vapor vessel to the working vessel. Liquid carbon dioxide is transferred from the working vessel to the wash vessel. After cleaning, at least a portion of spent liquid carbon dioxide is transferred from the wash vessel to the working vessel.

U.S. Pat. No. 5,339,844 relates to a system for cleaning of parts with liquefied gases without use of pumps and condensers. Supercritical fluids are employed in combination with ultrasonic cavitation.

U.S. Pat. No. 5,068,040 relates to a system for cleaning substrates of undesirable material. The substrate is simultaneously exposed to ultraviolet radiation and a dense fluid.

U.S. Pat. No. 6,085,762 relates to a system for supplying pulsed fluids to pressure vessels. Fluids are supplied to ballast tanks from pressure vessels. Fluids are injected from the ballast tanks into other processing vessels.

U.S. Pat. No. 6,500,605 B1 relates to a system for cleaning photoresist and residue from a substrate. The substrate is contacted with a cleaning composition of a supercritical carbon dioxide, an amine, a solvent and a rinse agent.

U.S. Patent Publication 2002/0112747 A1 relates to a process for cleaning water, entrained solutes and particulate matter from a semiconductor substrate. The substrate is immersed in a cleaning composition of a supercritical or liquid carbon dioxide and a cleaning adjunct and subjected to cyclical phase modulation.

U.S. Pat. No. 5,013,366 relates to a system for cleaning contaminants from a substrate by contacting with a dense gas above critical pressure. Temperature is then varied to shift the phase of the dense gas back and forth between liquid and critical state to enhance removal of contaminants.

It would be desirable to have a process and system for cleaning the surfaces of semiconductor wafers wherein the number and/or size of high-pressure pumps is minimized. It would further be desirable to have a process and system that employs a single high-pressure pump. It would further be desirable to have a process and system that permits momentary or surge flow rates of cleaning components and mixtures thereof. It would still be further desirable to have a process and system wherein additives may be incorporated without dedicated high-pressure pumps.

### SUMMARY OF THE INVENTION

A process for cleaning the surface of a semiconductor wafer. The process has the following steps: a) conveying a component selected from the group consisting of a dense gas component, a liquid component and a mixture thereof to a bellows accumulator having a bellows therein; b) applying an elevated pressure to the bellows sufficient to discharge the component from the bellows onto the surface of the wafer; and c) contacting the component with the surface of the wafer.

A process for cleaning the surface of a semiconductor wafer. The process has the following steps: a) conveying a dense gas component to a first bellows accumulator having a first bellows therein; b) conveying a liquid component to a second bellows accumulator having a second bellows therein; c) applying an elevated pressure to the first bellows sufficient to discharge the dense gas component from the first bellows onto the surface of the wafer; d) applying an elevated pressure to the second bellows sufficient to discharge the liquid component from the second bellows onto the surface of the wafer; and e) contacting the dense gas component or the liquid component with the surface of the wafer.

A process for cleaning the surface of a semiconductor wafer. The process has the following steps: a) conveying a dense gas component to a first accumulator wherein the first accumulator is a bellows accumulator having a bellows therein; b) conveying a liquid component to a second accumulator; c) applying an elevated pressure to the bellows sufficient to discharge the dense gas component from the bellows onto the surface of the wafer; d) applying an elevated pressure via the dense gas component to the second accumulator sufficient to discharge the liquid component from the second accumulator onto the surface of the wafer; and e) contacting the dense gas component and the liquid component with the surface of the wafer.

A system for cleaning the surface of a semiconductor wafer. The system has the following: a) a bellows accumulator having a bellows therein adapted to receive and retain a component selected from the group consisting of a dense gas component, a liquid component and a mixture thereof; b) a means for applying an elevated pressure to the component sufficient to discharge it from the bellows and c) a chamber adapted to receive and retain the semiconductor wafer and receive the component.

A system for cleaning the surface of a semiconductor wafer. The system has the following: a) a first accumulator wherein the first accumulator is a bellows accumulator having a bellows therein adapted to receive and retain a dense gas component; b) a means for applying an elevated pressure to the dense gas component sufficient to discharge it from the bellows; c) a second accumulator adapted to receive and retain a liquid component; d) a means for applying an elevated pressure to the liquid component sufficient to discharge it; and e) a chamber adapted to receive and retain the semiconductor wafer and receive the dense gas component and the liquid component.

A process for mixing a liquefied gas component and a liquid component. The process has the following steps: a) conveying a dense gas component to a first accumulator wherein said first accumulator is a bellows accumulator having a first bellows therein; b) conveying a liquid component to a second accumulator; c) applying an elevated pressure to said first bellows sufficient to discharge said dense gas component from said first bellows; d) applying an elevated pressure to said second accumulator sufficient to discharge said liquid component from said second accumulator; and e) combining the discharged dense gas component and the discharged liquid component to form a mixture.

### BRIEF DESCRIPTION OF THE DRAWINGS

FIG. 1 is a schematic representation of an embodiment of the system and process according to the present invention.

FIG. 2 is a schematic representation of another embodiment of the system and process according to the present invention.

### DETAILED DESCRIPTION OF THE PREFERRED EMBODIMENT

As used herein, the term “dense gas component” refers to a gas that is in substantially liquid or fluid form either through elevated pressure and/or cryogenic or reduced temperature. The gas is a compound(s) or element(s) that is substantially gaseous or vaporous at ambient temperature and pressure conditions.

Dense gas components useful in the present invention include, but are not limited to, those of carbon dioxide, fluorocarbons, chlorofluorocarbons and ammonia. The selection of a dense gas component will depend upon the nature of the end product or end use application.

Dense carbon dioxide is a preferred dense gas component in view of its common use in cleaning processes in electronics manufacturing. Dense carbon dioxide may exist in a liquid (fluid) form or as a supercritical fluid. In liquefied form, carbon dioxide is maintained at conditions wherein the temperature is less than the critical temperature, i.e. less than 304.128° K and the pressure is below the critical pressure, i.e. less than 7.377 megapascals (absolute). In the form of a supercritical fluid, carbon dioxide is maintained at conditions wherein one or the other or both of temperature and pressure are maintained above critical temperature and critical pressure, i.e. 304.128° K or more and 7.377 megapascals (absolute) or more, respectively. Carbon dioxide is typically supplied commercially as a compressed gas (liquefied) or as a cryogenic liquid.

The dense gas component is supplied to the process of the present invention as a direct feed or from a storage tank or vessel, optionally with a pump depending on pressure requirements. Although feed rate pressures are not critical, dense carbon dioxide is typically supplied to the process at preferably about 200 to about 1500 psia, more preferably about 300 to about 1200 psia, and most preferably about 300 to about 1000 psia. Dense carbon dioxide is typically delivered commercially at about 300 psia at cryogenic temperatures and about 700 to about 1000 psia at ambient temperature.

As used herein, the term “liquid component” refers to a compound(s) or element(s) that are in liquid or fluid form at ambient temperature and pressure conditions. In the system and process of the present invention, the liquid component will be compressed or subject to elevated pressures.

Liquid components useful in the present invention include, but are preferably organic compounds or solvents. Useful organic compounds include, but are not limited to, aliphatic alcohols, ketones, amines, ethers and aldehydes having 1 to 12 carbon atoms, heterocyclic compounds, such as pyridine, and acids such as hydrofluoric acid, sulfuric acid and hydrochloric acid. Isopropyl alcohol, hydrofluoric acid and pyridine are preferred liquid components in view of their common use in cleaning processes in electronics manufacturing.

Compressed gases, dense gases or other high pressure motive fluids may optionally used in the process of the present invention to propel the dense gas component and/or the liquid component and/or the mixture thereof throughout the process. In the instance of the cleaning process for electronics manufacturing, the gases also propel the cleaning mixtures at elevated pressure onto the surface of the wafer. The gases can be supplied at elevated pressures by any means known in the art, such as by a high pressure pump or by compressed storage tank or vessel. Preferably, the gases are supplied by means of a compressed storage tank or vessel to minimize the use of pumps. The gases are supplied at a pressure of preferably between about 1200 psia to about 5000 psia, more preferably between about 2000 to about 4000 psia, and most preferably between about 2800 psia to about 3200 psia.

The composition of the propellant gas is not critical so long as they are substantially non-corrosive and chemically inert with the system, mixture and components thereof. Although a gas is preferred as a motive fluid due to its relatively low density, it is also possible to use hydraulic oil or other high pressure motive fluids. The gas may be the same or different as that comprising the dense gas component. Preferred gases are the inert gases. Useful inert gases include, but are not limited to, nitrogen, helium, argon and mixtures thereof.

The accumulators used in the system and process of the present invention are adapted to temporarily store the dense gas component and/or the liquid component. The accumulators will also be adapted to discharge the contents either partially or totally. The accumulators can take the form of a storage tank, process vessel or the like. The accumulators can be of any type or construction so long as they are adapted to temporarily store and discharge their contents. One simple type of accumulator takes the form of a tank, wherein the headspace is pressurized with a compressed gas or a dense gas to discharge the contents of the tank. Another type employs a piston, wherein the piston actuates to discharge the contents. The piston is preferably actuated by a compressed gas or a dense gas or by other mechanical means, such as a ram or hydraulic pressure. Pressure may actively be applied to the contents of an accumulator as the contents is being discharged and/or may be applied in a passive, pent-up or stored form for subsequent release. A preferred type is a bellows accumulator, wherein an accordion-like bellows actuates to discharge its contents. The headspace of the bellows accumulator outside the bellows and inside the shell or casing is pressurized with a compressed gas or a dense gas to actuate the bellows. Useful bellows accumulators include those of the HYDROPAD™ brand by Flexicraft Inc.

The use of accumulators in the system and process of the present invention to convey the dense gas component and the liquid component affords significant advantages, e.g. (1) accumulators can be fabricated with anti-corrosive materials more economically than for pumps; (2) accumulators can permit the substitution of less expensive lower pressure pumps for more expensive higher pressure ones; (3) accumulators also provide process throughput advantages such as suppression of surges, dampening of pulses, accommodation of thermal expansion, and delivery and metering of precise or discrete quantities; and (4) bellows accumulators are particularly useful in discharging precise or discrete quantities of throughput at high flow rates.

Although an advantage of the present invention is to provide a system or process wherein the use of high-pressure pumps is minimized or that low-pressure pumps are substituted for such high-pressure pumps/compressors, the system and process of the present invention may optionally employ any type of low or high-pressure pump/compressor known in the art. Useful types of pumps include, but are not limited to, centrifugal, reciprocating, diaphragm, axial, rotary and piston.

A mixer may optionally be used to mix the dense gas component, the liquid component and any additives present. Both static and dynamic mixers are useful.

The system and process of the present invention are particularly useful in providing cleaning components and mixtures for electronics manufacturing, particularly during the manufacture of integrated circuits and microelectronic devices. Circuits are manufactured on the surfaces of semiconductor substrates, such as those of silicon wafers. A number of different processes are known, such 30 as lithography, photoresist deposition, photoresist developing, photoresist stripping and pattern etching. In such processes, cleaning steps may be employed in a manufacturing step and/or to remove by-products, residue, curing agents and contaminants. Cleaning preferably takes place in a pressurized chamber, wherein a cleaning component(s) or a mixture thereof is applied at elevated pressure, i.e. about 1000 psia or more, at a temperature of about 20 to about 80° C., to effect cleaning of the surface of the wafer. The substrate may be stationary or be spun or otherwise actuated to enhance cleaning. Cleaning typically takes place for about 5 seconds or more and more preferably between about 5 to about 40 seconds. Useful cleaning components include dense gases, such as dense carbon dioxide, as well as organic solvents, such as isopropyl alcohol. Cleaning may take place in a single stage operation at a constant temperature and pressure or may take place in multiple operation stages with different components for different exposure times at different temperatures and pressures. Circuit manufacturing and wafer cleaning processes are described, for example, in U.S. Pat. Nos. 5,013,366; 5,068,040; 5,339,844; 6,085,762; 6,306,564 B2; 6,500,605 B1; 6,536,059 B2 and U.S. Patent Publication No. 2002/0112747 A1, which are incorporated herein by reference in their entirety.

In one important type of lithography process, a layer of an organic photoresist is applied to the surface of the wafer. The photoresist is then etched. One or more cleaning component or a mixture of component is applied to the surface of the wafer to remove non-etched photoresist and etch residue.

An advantage of the process of the present invention is the ability to deliver dense gas and liquid components at high (elevated) pressure and high (elevated) flow rate without the use of high-pressure pumps. Bellows accumulators afford such advantages. Pressure chambers for cleaning semiconductor wafers can be charged to about 1000 psia or more and preferably about 2800 psia or more. Flow rates discharging from accumulators (or bellows therein in the case of bellows accumulators) will depend upon size and geometry of the system. Flow rates are sufficient to impart a flow velocity adjacent the wafer surface of about 10 cm/sec or more per second or more preferably about 50 cm/sec.

In a preferred cleaning process, a mixture of a dense gas component and a liquid component are charged to a pressure chamber containing the semiconductor wafer. The liquid component is preferably between from about 2 to about 10 wt % of the mixture based upon the combined weight of the dense gas component and the liquid component. The mixture is allowed to contact the wafer at high pressure, preferably between about 1000 psig and about 5000 psig. The mixture is allowed to contact the wafer for a period of time, preferably more than 5 seconds and most preferably between about 5 to about 40 seconds. The contact time allows time for the mixture to penetrate and soften residue and contaminants to facilitate removal. Optionally, then a second mixture of dense gas component and liquid component is forced through the pressure chamber at elevated flow rates to generate shear forces on the softened photoresist and residue, i.e. about 1 centimeters/second or more and most preferably about 50 centimeters/second or more adjacent the wafer surface at substantially the same pressure to remove residue and contaminants. Further optionally, in a third step, the pressure chamber may be rinsed out with dense gas component.

In a preferred embodiment, the present invention affords enhanced cleaning performance by maintenance of elevated pressure in the pressure vessel (containing the wafers) during the entire process of cleaning and/or rinsing. In the prior art, when used cleaning mixtures are released from the pressure vessel, a significant pressure drop occurs. The pressure drop denudes the effectiveness of the subsequent cleaning and/or rinsing cycles. In the process of the present invention, the accumulators are employed to maintain elevated pressure within the pressure vessel after used cleaning fluid with that vessel is released. This is accomplished by locating a release vessel downstream of the pressure vessel. The release vessel is sized to receive a portion or all of the used cleaning mixture. Preferably, the release vessel has a capacity substantially equivalent to the free headspace of the pressure vessel. In a typical cleaning cycle, the dense gas accumulator and the liquid component accumulator deliver a cleaning mixture to the pressure chamber at elevated pressure. The pressure vessel is sealed off for a period of time sufficient to effect cleaning. Then the pressure vessel is opened and contact with the elevated pressure supplied by the accumulators is reestablished. Then the pressure vessel and the release vessel are opened and the used cleaning mixture is released via pressure differential from the pressure vessel to the release vessel. The used cleaning mixture that exits the pressure vessel is replaced with additional cleaning mixture or dense gas from the accumulators. This replacement occurs contemporaneously and preferably instantly as the used cleaning mixture exits the pressure vessel. Then the pressure vessel is sealed off from contact with the accumulators and the release vessel to effect another cleaning or rinse cycle. While the pressure vessel is sealed off, the release vessel may be opened to drain the used cleaning mixture. When the subsequent cleaning or rinse cycle in the pressure vessel is complete, the steps by which the used cleaning mixture is released to the release vessel are repeated. If no additional cleaning or rinse cycles are desired, the pressure vessel is sealed off from contact with the accumulators and used cleaning mixture released therefrom via pressure differential through the release vessel.

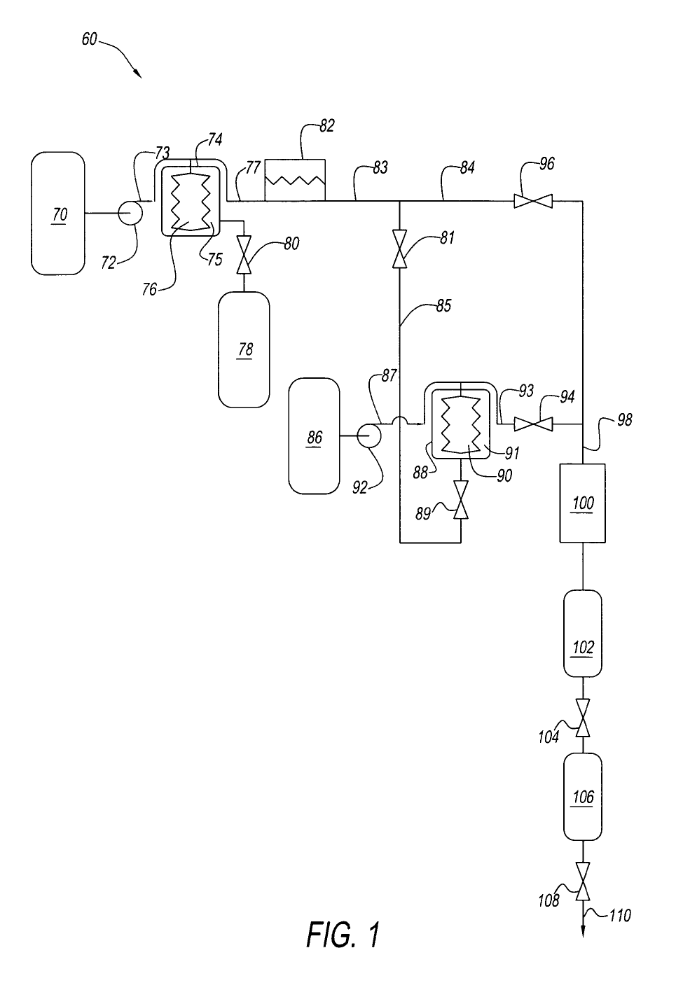

An embodiment of the present invention is shown in FIG. 1 and is generally referenced by the numeral 60. Carbon dioxide supply 70 supplies dense carbon dioxide to accumulator 74 via pump 72 and conduit 73. Carbon dioxide supply 72 preferably takes the form of a compressed gas tank or dense liquid storage vessel. Accumulator 74 is a bellows-type accumulator having a bellows 76 within a headspace 75. Dense carbon dioxide is supplied to bellows 76. Gas supply 78 supplies an inert gas, preferably helium, at about 3000 psia to headspace 75 of accumulator 74. The inert gas forces bellows 76 to discharge dense carbon dioxide out of accumulator 74 through conduit 77 and heat exchanger 82. Preferably, pressure is maintained at a constant level in headspace 75, and bellows 76 is freely moveable to allow partial or complete discharge of its contents Liquid supply 86 supplies a liquid component, preferably an organic solvent, to liquid accumulator 88 via pump 92 and conduit 87. Accumulator 88 is a bellows-type accumulator having a bellows 90 therein within a headspace 91. Pressure is supplied to bellows 90 by supply of dense carbon dioxide to headspace 91 of accumulator 88 via conduit 85 and valve 81. Preferably, pressure is maintained at a constant level in headspace 91, and bellows 90 is freely moveable to allow partial or complete discharge of its contents. A liquid component is discharged from bellows 90 via conduit 93 and valve 94 to combine with dense carbon dioxide, which is supplied via conduit 84 and valve 96. The liquid component and the dense carbon dioxide are combined to form a cleaning mixture, which is passed through conduit 98 to a static mixer 100 to process chamber 102, in which the surfaces of silicon wafers (not shown) are cleaned at elevated pressure. After cleaning of the surfaces of the wafers, valve 104 and release vessel 106 are opened to receive some or all of the used cleaning mixture. During the release of the used cleaning mixture from pressure vessel 102 to release vessel 106, elevated pressure within vessel 102 is substantially maintained via pressure from accumulators 74 and 88. Used cleaning mixutrue is released from vessel 106 via valve 108 and drain 110.

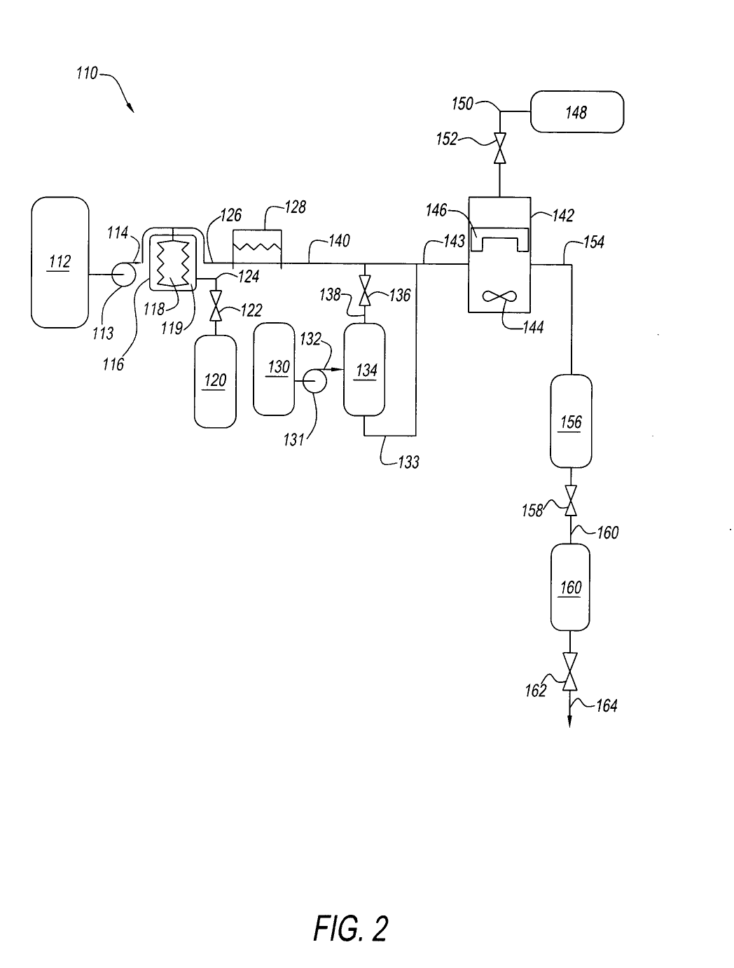

Another embodiment of the present invention is shown in FIG. 2 and is generally referenced by the numeral 110. Carbon dioxide supply 112 supplies dense carbon dioxide to accumulator 116 via pump 113 and conduit 114. Carbon dioxide supply 112 preferably takes the form of a compressed gas tank or dense liquid storage vessel. Accumulator 116 is a bellows-type accumulator having a bellows 118 therein within a headspace 119. Inert gas supply 120 supplies an inert gas, preferably helium, to headspace 119 of accumulator 116 through valve 122 and conduit 124. The inert gas forces bellows 118 to discharge dense carbon dioxide through conduit 126 and heat exchanger 128. Preferably, pressure is maintained at a constant level in headspace 119 and bellows 118 freely moveable to allow partial or complete discharge of its contents. Liquid supply 130 supplies a liquid component, preferably isopropyl alcohol, to liquid accumulator 134 via pump 131 and conduit 132. Accumulator 134 takes the form of a storage vessel for the liquid component. Accumulator 134 discharges liquid component via headspace pressure from dense carbon dioxide supplied via conduit 136 and valve 138. Liquid component is discharged from accumulator 134 via conduit 133 to combine with dense carbon dioxide, which is supplied via conduit 140. The liquid component and the dense carbon dioxide are combined to form a cleaning mixture, which is passed through conduit 143 an accumulator 142, which has an impeller 144 and a piston 146. Impeller 144 ensures substantially homogenous mixing of components. Inert gas supply 148 provides inert gas pressure at about 3000 psia via conduit 150 and valve 152 to actuate piston 146 downward. After cleaning of the surfaces of the wafers, valve 158 and release vessel 160 are opened to receive some or all of the used cleaning mixture. During the release of the used cleaning mixture from pressure vessel 156 to release vessel 160, elevated pressure within vessel 156 is substantially maintained via pressure from accumulators 116 and 134. Used cleaning mixture is released from vessel 160 via valve 162 and drain 164.

Cleaning components and solutions useful in the present invention may have additives to enhance performance and efficacy. Additives include, but are not limited to, surfactants, anti-corrosion agents, co-solvents, lubricants, stabilizers and viscosity modifiers.

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

1. A process for cleaning a surface of a semiconductor wafer, which comprises:
a) conveying a component selected from the group consisting of: a dense gas component, a liquid component and a mixture thereof to a bellows accumulator having a bellows therein;
b) applying an elevated pressure to said bellows sufficient to discharge said component from said bellows onto said surface of said wafer; and
c) contacting said component with said surface of said wafer.

2. The process of claim 1, wherein said dense gas component is dense carbon dioxide or supercritical carbon dioxide.

3. The process of claim 2, wherein said liquid component is an organic liquid component soluble or miscible in dense carbon dioxide or supercritical carbon dioxide.

4. The process of claim 1, wherein said liquid component is selected from the group consisting of: isopropyl alcohol, hydrofluoric acid, pyridine and combinations thereof.

5. The process of claim 1, wherein said elevated pressure is applied to said bellows via a compressed gas.

6. The process of claim 1, wherein said component is a mixture and is contacted with said surface of said semiconductor wafer in a pressure chamber, wherein the component charges the pressure chamber to a free headspace pressure of about 1000 psia or more, and wherein said bellows discharges said mixture at a flow rate to impart a component velocity of about 10 cm/sec or more.

7. The process of claim 1, wherein said component is a mixture and is contacted with said surface of said semiconductor wafer in a pressure chamber, wherein the component charges the pressure chamber to a free headspace pressure of about 2400 psia or more, and wherein said bellows discharges said mixture at a flow rate sufficient to impart a component velocity next to the wafer surface of about 50 cm/sec or more.

8. A process for cleaning a surface of a semiconductor wafer, which comprises:
a) conveying a dense gas component to a first bellows accumulator having a first bellows therein;
b) conveying a liquid component to a second bellows accumulator having a second bellows therein;
c) applying an elevated pressure to said first bellows sufficient to discharge said dense gas component from said first bellows onto a surface of said wafer;
d) applying an elevated pressure to said second bellows sufficient to discharge said liquid component from said second bellows onto said surface of said wafer; and
e) contacting said dense gas component or said liquid component with said surface of said wafer.

9. The process of claim 8, wherein said elevated pressure is applied to said second bellows via said dense gas component.

10. The process of claim 8, wherein said dense gas component and said liquid component are mixed prior to application to said surface of said wafer.

11. A process for cleaning a surface of a semiconductor wafer, which comprises:
a) conveying a dense gas component to a first accumulator wherein said first accumulator is a bellows accumulator having a first bellows therein;
b) conveying a liquid component to a second accumulator;
c) applying an elevated pressure to said first bellows sufficient to discharge said dense gas component from said first bellows onto said surface of said wafer;
d) applying an elevated pressure via said dense gas component to said second accumulator sufficient to discharge said liquid component from said second accumulator onto said surface of said wafer; and
e) contacting said dense gas component and said liquid component with said surface of said wafer.

12. The process of claim 11, wherein said dense gas component and said liquid component are mixed prior to application to said surface of said wafer.

13. A system for cleaning a surface of a semiconductor wafer, which comprises:
a) a bellows accumulator having a bellows therein adapted to receive and retain a component selected from the group consisting of a dense gas component, a liquid component and a mixture thereof;
b) a means for applying an elevated pressure to said component sufficient to discharge it from said bellows;
c) a chamber adapted to receive and retain said semiconductor wafer and receive said component.

14. A system for cleaning a surface of a semiconductor wafer, which comprises:
a) a first accumulator wherein said first accumulator is a bellows accumulator having a bellows therein adapted to receive and retain a dense gas component;
b) a means for applying an elevated pressure to said dense gas component sufficient to discharge it from said bellows;
c) a second accumulator adapted to receive and retain a liquid component;
d) a means for applying an elevated pressure to said liquid component sufficient to discharge it from the second accumulator;
e) a chamber adapted to receive and retain said semiconductor wafer and receive said dense gas component and said liquid component.

15. The system of claim 14, further comprising a means adapted to receive and mix said dense gas component and said liquid component prior to said chamber.

16. A process for mixing a liquefied gas component and a liquid component, which comprises:
a) conveying a dense gas component to a first accumulator wherein said first accumulator is a bellows accumulator having a first bellows therein;
b) conveying a liquid component to a second accumulator;
c) applying an elevated pressure to said first bellows sufficient to discharge said dense gas component from said first bellows;
d) applying an elevated pressure to said second accumulator sufficient to discharge said liquid component from said second accumulator;
e) combining the discharged dense gas component and the discharged liquid component to form a mixture.

17. The process of claim 16, wherein the second accumulator is a second bellows accumulator.

18. The process of claim 16, wherein said dense gas component is dense carbon dioxide or supercritical carbon dioxide.

19. The process of claim 16, wherein said liquid component is an organic liquid component soluble or miscible in dense carbon dioxide or supercritical carbon dioxide.

20. The process of claim 16, wherein said liquid component is selected from the group consisting of: isopropyl alcohol, hydrofluoric acid, pyridine and combinations thereof.

21. The process of claim 16, wherein the elevated pressure is applied passively.
